(19) United States
(12) Patent Application Publication
(10) Pub. No.: US 2013/0241760 A1
(43) Pub. Date: Sep. 19, 2013

(54) OBJECT DETECTION DEVICE AND METHOD THEREOF

(71) Applicants: Yao-Jen CHEN, Zhubei City (TW); Chun-Kai Derrick WEI, Zhubei City (TW); Jui-Hsiang CHANG, Zhubei City (TW); Ming-Li CHENG, Zhubei City (TW); Rung-Chi CHUANG, Zhubei City (TW); Yu-Jen LIN, Zhubei City (TW); Hsiao-Ping YUAN, Zhubei City (TW); Tien-Hsiung SUNG, Zhubei City (TW)

(72) Inventors: Yao-Jen CHEN, Zhubei City (TW); Chun-Kai Derrick WEI, Zhubei City (TW); Jui-Hsiang CHANG, Zhubei City (TW); Ming-Li CHENG, Zhubei City (TW); Rung-Chi CHUANG, Zhubei City (TW); Yu-Jen LIN, Zhubei City (TW); Hsiao-Ping YUAN, Zhubei City (TW); Tien-Hsiung SUNG, Zhubei City (TW)

(21) Appl. No.: 13/470,489

(22) Filed: May 14, 2012

(30) Foreign Application Priority Data
Mar. 16, 2012 (TW) 101109035

(51) Int. Cl. G01S 13/04

(52) U.S. Cl. 342/27

(57) ABSTRACT

An object detection device includes a RF emitter composed of a RF emitting module and an emitter antenna for emitting an EM wave, a RF receiver composed of a RF receiving module and a RF antenna for receiving a reflected EM wave by a predetermined object and a processor connected to the RF emitter and the RF receiver to process the received reflected EM wave so as to obtain a received signal strength indicator (RSSI) such that existence of the object is determined based on fluctuation of the RSSI when compared with a predetermined threshold value.

### CROSS-REFERENCE TO RELATED APPLICATION

This application claims priority from application No. 101109035, filed on Mar. 16, 2012 in the Taiwan Intellectual Property Office.

### FIELD OF THE INVENTION

The invention relates to an object detection device for the purpose of detecting whether there is an object located at a predetermined location so as to know if there is an open space for parking and achieve the goal of easy management of available spaces for parking space users, and more particularly, to an object detection device and method thereof such that available spaces may be easily spotted and provided to the needed.

### BACKGROUND OF THE INVENTION

Nowadays, as the number of cars and motorcycles grows larger and larger with the non-stop growing industry, available spaces for, such as, parking, storage or the like are becoming a valuable asset in the market. Taking the parking space in a mall for instance, when the shopper enters the parking lot and is ready shop in the mall, the shopper drives around the parking lot looking for an available space to park. Often in time, the parking space is not easy to spot and the shopper may need to drive over and over again to hunt for the space, which is quite inefficient and costly for the gasoline consumed while hunting for the parking space.

In order to avoid such a waste of time and energy, some management method adopted a so called “flux” control to limit the overall number of parking cars. By using this method, only the number of available parking spaces is known, but not where the actual parking space is located. As a result, when the parking space is enough, it is easy for users to spot the space by naked eyes. However, when the parking space is limited, the shopper still needs to drive around to hunt for the space himself/herself.

In order to obviate the aforementioned problem, U.S. Pat. No. 6,147,624 titled “Method and Apparatus For Parking Management System For Locating Available Parking Space” is disclosing a sensing apparatus used in the parking lot. The apparatus involves a sensor equipped with infrared characteristic so that the user may know in real-time where the available parking space is and thus time and energy used for searching for the parking space are saved. Even though this sensor saves lots of time and energy for the user searching for available parking space, the sensor is easily affected by environmental factors such as outdoor temperature. That is, when the outdoor temperature is high, the sensor may mistakenly be initiated.

Other method involves using a magnetic coil embedded in the ground. From the variation of the magnetic field, the operator can easily know which parking spot is being taken and which is still available. This kind of magnetic coil requires an electricity source to keep the function working and also it is easily affected by the magnetic field of the earth. Frequent adjustment of the accuracy of the magnetic field of the coil is required.

A further system involves using a RF emitter and an electronic tag mounted onto user's car. By using the RF emitter and the electronic, the operator of the parking lot may easily find out which parking spot is occupied and which is still available. Using this system does simplify the trouble of finding an available spot and save lots of time searching for one. Yet, this system requires each and every user to mount its unique electronic tag so that the RF emitter may pick up and process signals reflected back from the tags.

After the above introduction, it seems that the current system can not solve the problem without leaving some other troubling issues.

### SUMMARY OF THE INVENTION

The primary objective of the present invention is to provide an object detection device having a RF emitter composed of a RF emitter module and an emitting antenna for sending out an electromagnetic (EM) wave, a RF receiver composed of a RF receiving module and a receiving antenna for receiving an EM wave reflected by a predetermined object, a processor connected to the RF emitter and the RF receiver to process the reflected EM wave from the RF receiver to result in a received signal strength indicator (RSSI) and to determine whether an object exists should the fluctuation of the RSSI be larger than a thresh value.

In one embodiment, the RF emitter and the RF receiver are placed in parallel.

In one embodiment, the object detection device of the present invention further has a casing with the RF emitter, the RF receiver and the processor received therein. The casing has a baffle securely mounted therein to separate the RF emitter and the RF receiver. The casing may be made of a suitable metal and mounted on a shelf, in the ground or in the wall.

In another embodiment, the carrier wave of the electromagnetic wave is set to be within industrial scientific medical band (ISM band), i.e. 902˜928 MHz, 2.400˜2.4835 GHz or 5.725˜5.875 GHz.

In still another embodiment, the antenna is a panel antenna, a highly directive antenna or an array antenna.

Still, another objective of the present invention is to provide an object detection method using the object detection device so introduced.

In order to achieve the aforementioned objective, the object detection method of the present invention includes the following steps:

transmitting an EM wave;

receiving the EM wave reflected by a predetermined object;

obtaining a received signal strength indicator (RSSI) in according to the received EM wave;

determining if fluctuation of the RSSI is larger than a thresh value; and

judging existence of the object.

In a preferred embodiment of the present invention, the EM wave is transmitted periodically.

In a preferred embodiment of the present invention, the EM wave is transmitted in every two minutes.

With the device of the present invention, when the EM wave is blocked by an object and the EM wave is thus reflected, intensity of the wave received by the RF receiver is much larger than the situation where there is no object blocking the wave and the RF receiver receives only very low intensity of the EM wave. As a result, the intensity fluctuation of the wave is used as an indicator to show there is an object located at a predetermined position or not.

### BRIEF DESCRIPTION OF THE DRAWINGS

FIG. 1 is a schematic view showing the arrangement of the object detection device of the present invention;

FIG. 2 is a flow chart showing the steps applied in the method of the present invention; and

FIG. 3 is a schematic side view showing the application of the object detection device to detect if there is a car sitting atop of the device.

### DETAILED DESCRIPTION OF THE INVENTION

In order to describe details of the preferred embodiment of the present invention, description of the structure, and the application as well as the steps are made with reference to the accompanying drawings. It is learned that after the description, any variation, modification or the like to the structure and the steps of the embodiments of the preferred embodiment of the present invention is easily made available to any person skilled in the art. Thus, the following description is only for illustrative purpose only and does not, in any way, try to limit the scope of the present invention.

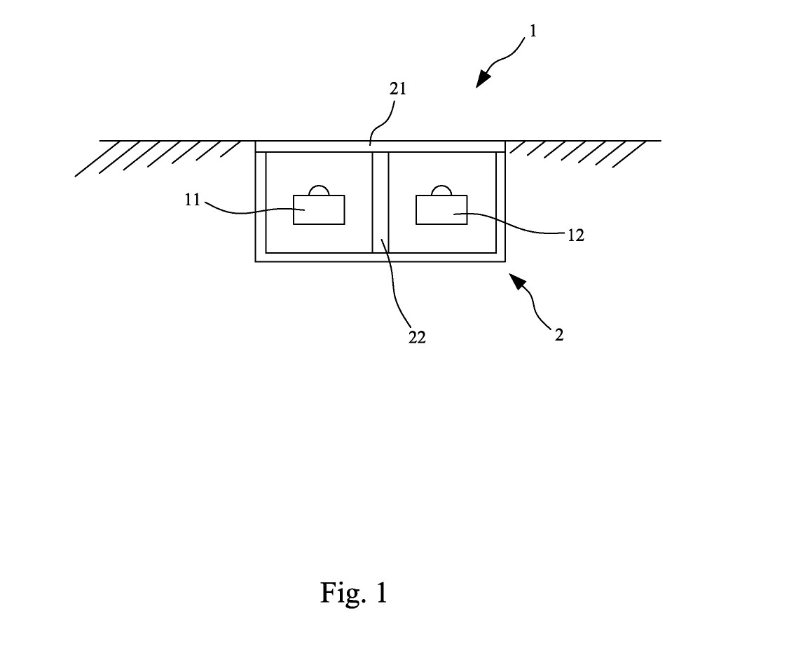

With reference to FIG. 1 of the preferred embodiment of the present invention, it is noted that the object detection device 1 includes a RF emitter 11, a RF receiver 12 and a processor (not shown).

The RF emitter 11 is composed of a RF emitter module and an emitter antenna which can be a panel antenna, a highly directive antenna or an array antenna. However, the list of the variations of the antenna is only an exemplary list, not a list of limitation of the antenna. The RF emitter 11 is able to transmit an electromagnetic (EM) wave and the carrier wave of the EM wave may be set within the band of Industrial Scientific Medical band (ISM band), i,e, 902˜928 MHz, 2.400˜2.4835 GHz or 5.725˜5.875 GHz. This band is set in accordance with U.S. FCC regulations and is open to industrial, scientific and medical fields. There is no involvement of any licensing restriction and any person skilled in the art can easily understand the use of this band without further description.

The RF receiver 12 is composed of a RF receiving module and a receiving antenna which can be a panel antenna, a highly directive antenna or an array antenna to receive EM wave which is transmitted by the RF emitter 11 and reflected by an object. Within this embodiment, it is learned that the RF emitter 11 and the RF receiver 12 are placed in parallel and are preferably separated from each other for a predetermined distance.

When in application, the processor may be a chip composed of a memory, a clock generator, a register, an analog/digital switch and a signal processor. The chip is preinstalled with RSSI (received signal strength indicator) parameters for judgment of signal strength. Such a technique is well known in the art and details of the related art are thus omitted for brevity. However, a predetermined thresh value of the signal strength can be set as required. That is, when the thresh value is adjusted lower than normal, the sensitivity of the device of the present invention is relatively increased. On the contrary, if the thresh value of the object detection device of the present invention is adjusted higher than normal setting, the sensitivity of the device is relatively decreased. By adjustments, users may obtain a perfect thresh value for use with what is required to fit in the environment.

Furthermore, the device of the present invention may also include a casing 2 and the RF emitter 11 and the RF receiver 12 are received inside the casing 2. The casing 2 may be mounted on a shelf, in the ground or in the wall and is waterproof, dustproof and has the ability to withstand extreme temperature change. N order to do that, it'd be better that the sidewalls of the casing 2 are made of materials that can be reinforced.

In order to ensure that the RF emitter 11 can transmit EM wave and the RF receiver 12 can receive the reflected EM wave that is originally transmitted by the RF transmitter 11, the casing 2 is composed of a lid 21 capable of allowing EM wave penetration without any blockage. On the other hand, in order to prevent any influence from EM wave transmitted by other sources in the environment, it'd be better that the sidewalls are made of materials capable of blocking any penetration of EM wave.

Furthermore, to prevent the RF receiver 12 from directly receiving the EM wave transmitted by the RF emitter 11, a baffle 22 is securely mounted inside the casing 2. With the mounting of the baffle 22, the EM wave transmitted from the RF emitter 11 can be avoided from being received directly by the RF receiver 12.

A battery may also be provided inside the casing 2 to provide electricity to both the RF emitter 11 and the RF receiver 12. In addition, the RF emitter 11, the RF receiver 12 and the processor may be integrated together and formed as a module to lower the cost and meet the mass production demands.

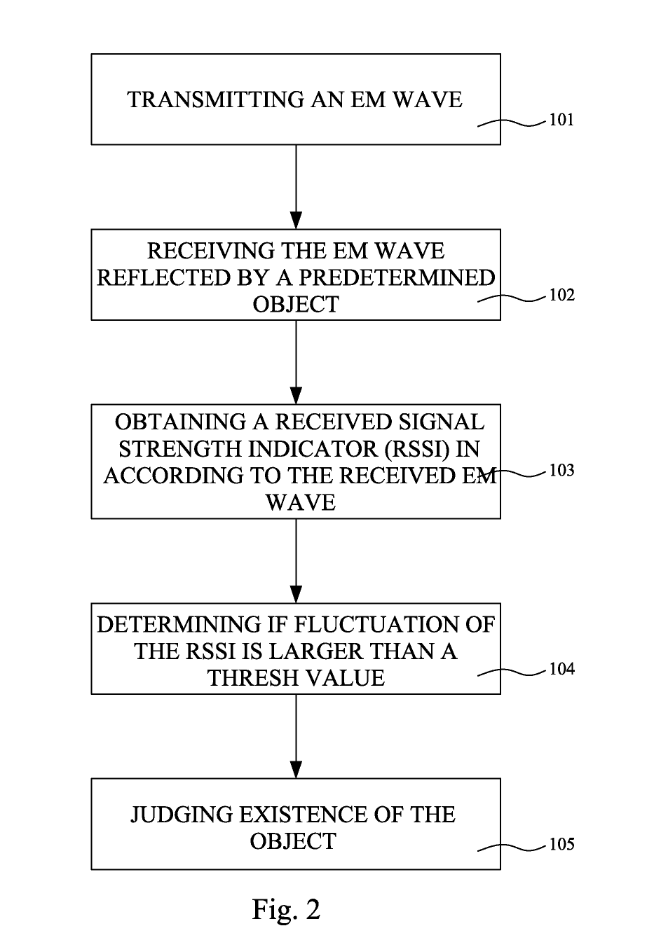

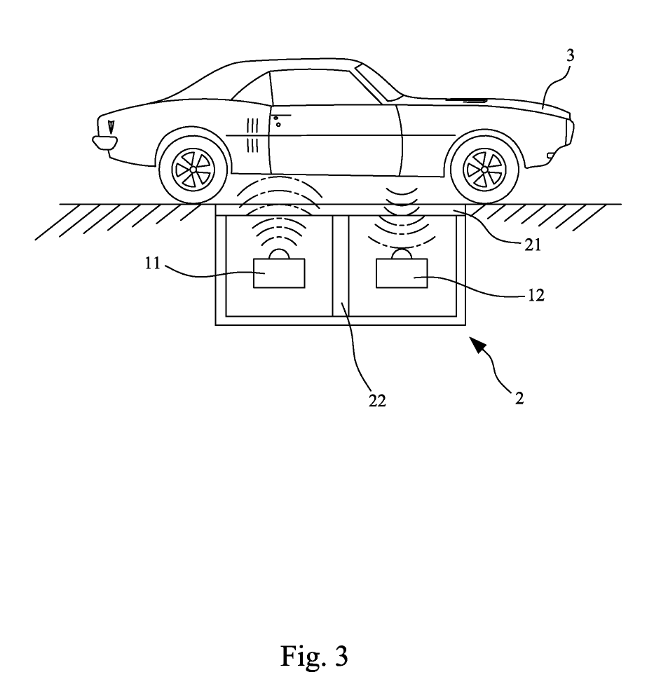

With reference to FIGS. 2 and 3, it is to be noted that the object detection method of the present invention includes the steps of:

101 transmitting EM wave;

102 receiving the EM wave reflected by an object;

103 obtaining a received signal strength indicator (RSSI) in according to the received EM wave;

104 determining if fluctuation of the RSSI is larger than a threshold value; and

105 judging existence of the object in according to the judgment.

In the step of transmitting EM wave 101, the emitter antenna of the RF emitter 11 emits the EM wave. As shown in FIG. 3. in this embodiment, a vehicle 3 is sitting on top of the device of the present invention and blocking the traveling path of the EM wave emitted by the emitter antenna. Because of the vehicle 3, the EM wave will be so reflected and received by the RF receiver 12. During application of the device, in order to save electricity and prolong the lifespan of the device, the EM wave is emitted and received periodically. Preferably, the period is set to be every two minutes. However, the time period for emitting and receiving the EM wave can be set to any appropriate timeframe.

Another notice is that the vehicle 3 used in the preferred embodiment may also be another type of object, such as a container a box or any thing that is made of a material with high reflective feature to the EM wave, i.e., metal.

In 102 step, the receiving antenna of the RF receiver 12 receives the reflected EM wave by the vehicle 3.

In the step of obtaining a received signal strength indicator (RSSI) in according to the received EM wave 103, the processor processes the RSSI to know the strength of the signal.

In step 104, the processor determines if the fluctuation of the signal strength is larger than a predetermined threshold value, e.g. 10 dBm (decibels relative to one milliwatt).

In step 105, the processor will determine if there is an object in according to the received signal strength. That is, if the signal strength fluctuation is larger than a predetermined threshold value, the processor determine the existence of the object.

In real practice, the processor is first implemented in the field to test the signal strength. For example, the initial signal strength fluctuates between −78 dBm˜−80 dBm and the RF emitter 11 has an initial emission strength of −30 dBm. When the vehicle 3 is placed on top of the device of the present invention, the variation of RSSI is −65 dBm and the range of the RSSI change is 14 dBm. The RSSI change is larger than the predetermined threshold value, e.g., 10 dBm. A confirmation of the existence of the object is obtained.

The initial emission strength of the RF emitter 11 can be adjusted to have the best result when used to detect whether there is an object. When placing an object on top of the device of the present invention and the RSSI change does not exceed the predetermined value, the initial emission strength of the RF emitter should be adjusted within the range of −30 dBm˜1 dBm. However, the range is only for illustrative purpose and does not exclude the possibility of other ranges.

It is to be noted that the object detection device of the preferred embodiment of the present invention can be used to detect anything made of a material which is highly reflective to the emitted EM wave, as such a container, a vehicle, or even a metal box can be treated as the object. In collaboration with the mesh network, any user can implement the object detection device in a system to run a perfect parking lot, a storage space or the like.

A further notice is that different types and brands of vehicles would have different reflection to the EM wave. Experiments are required to adjust the initial emission strength of the RF emitter 11 so as to acquire the best result and achieve the purpose of the present invention.

The object detection device of the present invention may be mounted on a shelf, in the ground, or in the wall to avoid interference by other environmental EM sources. Further, the emission or receiving of the EM wave is periodically implemented, thus energy is saves.

While the invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. An object detection device comprising:
a RF emitter composed of a RF emitting module and an emitter antenna for emitting an EM wave;
a RF receiver composed of a RF receiving module and a RF antenna for receiving a reflected EM wave by a predetermined object; and
a processor connected to the RF emitter and the RF receiver to process the received reflected EM wave so as to obtain a received signal strength indicator (RSSI) such that existence of the object is determined based on fluctuation of the RSSI when compared with a predetermined threshold value.

2. The device as claimed in claim 1, wherein the RF emitter and the RF receiver are placed in parallel relative to one another.

3. The device as claimed in claim 1, wherein the EM wave has a carrier wave within industrial scientific medical band (ISM band), which is 902˜928 MHz, 2.400˜2.4835 GHz or 5.725˜5.875 GHz.

4. The device as claimed in claim 1 further comprising a casing composed of a lid and sidewalls to receive therein the RF emitter and the RF receiver.

5. The device as claimed in claim 4, wherein the casing is composed of a lid made of a material capable of allowing penetration of the EM wave and sidewalls made of a material incapable of allowing penetration of the EM wave.

6. The device as claimed in claim 2 further comprising a casing composed of a lid and sidewalls to receive therein the RF emitter and the RF receiver.

7. The device as claimed in claim 6, wherein the casing is composed of a lid made of a material capable of allowing penetration of the EM wave and sidewalls made of a material incapable of allowing penetration of the EM wave.

8. The device as claimed in claim 3 further comprising a casing composed of a lid and sidewalls to receive therein the RF emitter and the RF receiver.

9. The device as claimed in claim 8, wherein the casing is composed of a lid made of a material capable of allowing penetration of the EM wave and sidewalls made of a material incapable of allowing penetration of the EM wave.

10. The device as claimed in claim 5 further comprising a baffle mounted inside the casing to separate the RF emitter and the RF receiver.

11. The device as claimed in claim 7 further comprising a baffle mounted inside the casing to separate the RF emitter and the RF receiver.

12. The device as claimed in claim 9 further comprising a baffle mounted inside the casing to separate the RF emitter and the RF receiver.

13. The device as claimed in claim 10, wherein the emitter antenna and the receiving antenna are panel antenna, high directive antenna or mesh antenna.

14. The device as claimed in claim 11, wherein the emitter antenna and the receiving antenna are panel antenna, high directive antenna or mesh antenna.

15. The device as claimed in claim 12, wherein the emitter antenna and the receiving antenna are panel antenna, high directive antenna or mesh antenna.

16. An object detection method comprising the steps of:
transmitting an EM wave;
receiving the EM wave reflected by a predetermined object;
obtaining a received signal strength indicator (RSSI) in according to the received EM wave;
determining if fluctuation of the RSSI is larger than a thresh value; and
judging existence of the object.

17. The method as claimed in claim 16, wherein the EM wave is transmitted and received periodically.

18. The method as claimed in claim 16, wherein the EM wave is transmitted in every two minutes.
